(19) United States
(12) Patent Application Publication
(10) Pub. No.: US 2026/0133719 A1
(43) Pub. Date: May 14, 2026

(54) Memory Controller and Command Buffer for Parallel Metadata Access and Enhanced Error Correction

(71) Applicant: Rambus Inc., San Jose, CA (US)

(72) Inventor: Thomas Vogelsang, Jericho, VT (US)

(21) Appl. No.: 19/369,858

(22) Filed: Oct. 27, 2025

Related U.S. Application Data
(60) Provisional application No. 63/718,033, filed on Nov. 8, 2024.

(51) Int. Cl. G06F 3/06

(52) U.S. Cl. CPC G06F 3/0659; G06F 3/0619; G06F 3/0673

(57) ABSTRACT

A memory system includes a command buffer that services commands from a host processer via a memory controller to access data interleaved across multiple DRAM devices. The memory controller uses parity bits augmented with metadata for improved error detection and correction. Cache lines of data and parity bits are interleaved across the DRAM devices. Metadata for each cache line is stored in a separate, device-specific address in just one of the DRAM devices. The memory controller and command buffer save time and power by grouping accesses for metadata stored in different devices.

### FIELD OF THE INVENTION

The subject matter presented herein relates to error correction for memory systems and modules.

### BACKGROUND

Personal computers, workstations, and servers include at least one processor, such as a central processing unit (CPU), and some form of memory system that includes dynamic, random-access memory (DRAM). The processor executes instructions and manipulates data stored in the DRAM.

DRAM stores binary bits by alternatively charging or discharging capacitors to represent the logical values one and zero. The capacitors are exceedingly small, and their stored charges can be upset by electrical interference or high-energy particles. The resultant changes to the stored instructions and data produce undesirable computational errors.

Some computer systems, such as high-end servers, employ various forms of error detection and correction to manage DRAM errors, or even more permanent memory failures. The general idea is to add storage for extra information that can be used to identify and correct for errors. By way of example, conventional servers that support error correction commonly include memory modules that read and write data in 512-bit (512b) chunks called “cache lines.” Cache lines are spread across four DRAM dies that each communicates 512b/4=128b per read or write transaction. Adding a fifth DRAM die allows the memory to communicate an additional 128b of parity data per transaction, which increases the size of a cache line to 640b per transaction. The 128b parity bits are calculated for each 512b write transaction and the resulting 640b cache line is stored together at the same memory address. The data and parity data are read back together and the parity bits are used for error detection and correction (EDC) robust enough to correct for any single DRAM die failure if the failing die is known.

Parity data sufficient to correct an error may be insufficient to identify the source of the error. A defective resource, such as a bad connection or memory device, can thus go uncorrected or even unnoticed. Additional data-sometimes called “metadata”—can be stored with data and parity bits to identify sources of errors and thus avoid silent data corruption. Unfortunately, this improvement requires additional memory and can diminish memory speed performance.

### BRIEF DESCRIPTION OF THE DRAWINGS

The present invention is illustrated by way of example, and not by way of limitation, in the figures of the accompanying drawings.

FIG. 1 depicts a memory system 100 in which a command buffer 105 services commands from a host 110 processor via a memory controller 115 to access data interleaved across five memory (DRAM) devices 120.

FIG. 2 illustrates how system 100 of FIG. 1 provides, stores, and groups metadata for a group of four cache lines 200.

FIG. 3 is a flowchart 300 illustrating a method, coordinated by memory controller 115 and command buffer 105, to read cache lines and metadata from DRAM devices 120 and use returned data, parity, and metadata for EDC.

FIG. 4 is a flowchart 400 illustrating a method, coordinated by memory controller 115 and command buffer 105, to write cache lines and metadata from memory controller 115 to DRAM devices 120 in a manner consistent with the example of FIG. 2.

FIG. 5 is a timing diagram 500 illustrating how a sequence of four read transactions, cache lines with parity and data bits, and two related metadata transactions can be pipelined to maximize communication bandwidth.

### DETAILED DESCRIPTION

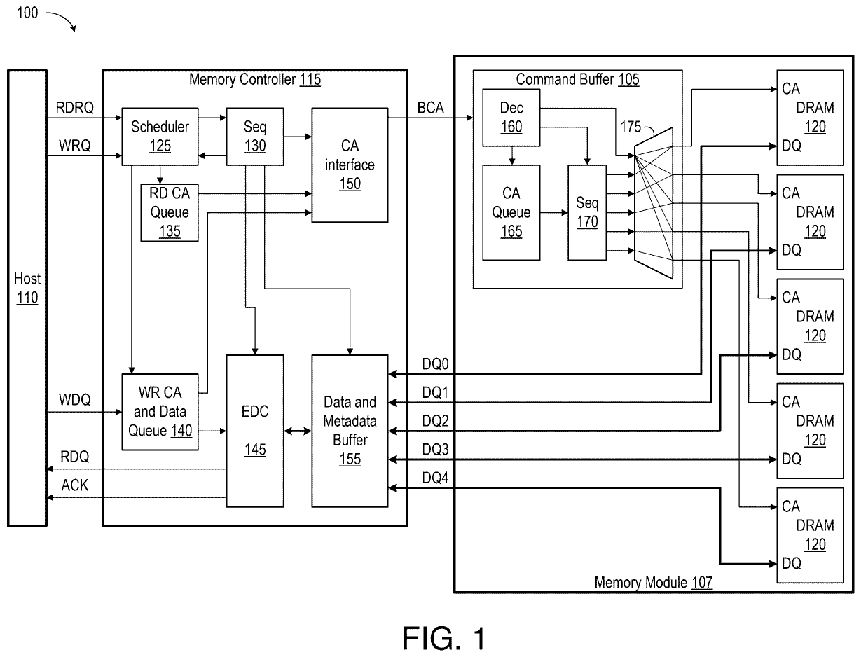

FIG. 1 depicts a memory system 100 in which a command buffer 105 on a memory module 107 services commands from a host processer 110 via a memory controller 115 to access data interleaved across five memory (DRAM) devices 120. Memory controller 115 uses parity bits augmented with metadata for improved error detection and correction (EDC). Cache lines of data and parity bits are interleaved across the five devices 120. Metadata for each cache line is stored in a separate, device-specific address in just one of devices 120. Each cache-line access thus requires a separate access for the associated metadata. Memory controller 115 and command buffer 105 save time and power by grouping accesses for metadata stored in different devices 120. If two cache lines spread across five devices 120 have corresponding metadata in different devices, for example, the metadata for both cache lines can be read in one metadata transaction targeting different device addresses rather than one for each cache line. Worst case, the metadata for both would be stored in the same device, necessitating a metadata transaction for each cache-line access, but grouping metadata transactions when possible reduces the average number of metadata transactions.

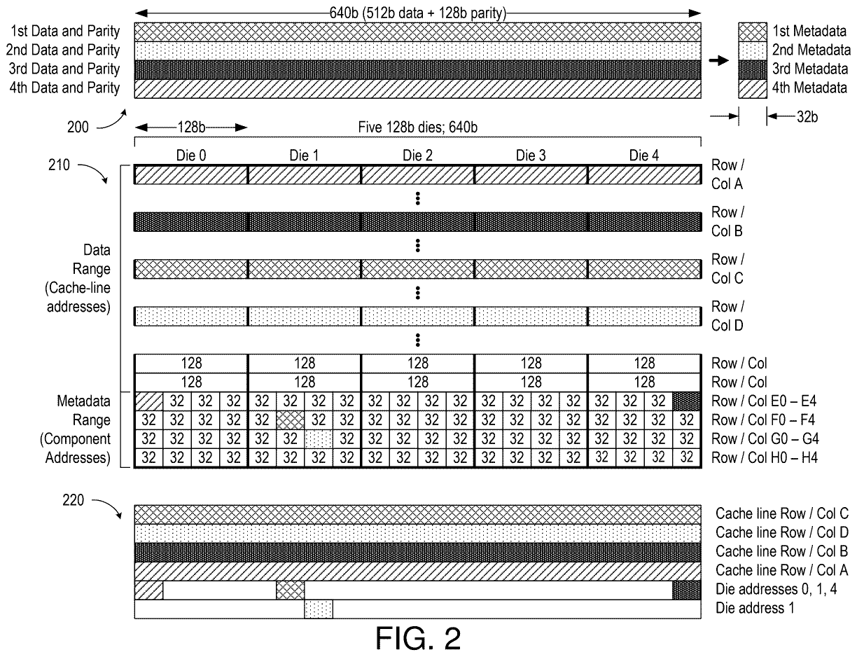

FIG. 2 illustrates how system 100 of FIG. 1 provides, stores, and groups metadata for a group of four cache lines 200. In this context, a “cache line” refers to the signals to be read from or written to memory and includes both 512 bits (512b) of data and 128 parity bits. Memory controller 115 calculates and appends 32b of metadata for each cache line, for a total of 672b. Shading identifies cache-line/metadata pairs.

Memory devices 120 each include one or more memory dies that transact in 128b bursts, and each cache line is efficiently distributed across five devices. Columns 210 of memory addresses show how cache lines 200 may be spread across five dies, each cache line occupying a respective cache-line address that is provided to all five dies. The column width is 640b, the same size as a cache line, so a separate range of addresses is set aside for metadata. Each memory device 120 has an address space consisting of a range of row addresses and column addresses. A cache line is uniquely identified by a row address issued with an ACT command and a column address issued with a RD or WR command. A part of the row-address space is reserved for data and parity, in this example labeled row/col A, B, C, and D. Another part of the row-address space is reserved for the additional metadata, in this example labeled row/col E, F, G, and H. This space is further characterized by appending the number 0 to 4 to signify that in a metadata access each die can be accessed with a different device-specific address. In this example, the metadata associated with cache-line addresses row/col C and row/col D both occupy the same Die 1; the metadata associated with cache-line addresses row/col A and row/col B are in dies Die 0 and Die 4, respectively. Though not shown, cache lines and metadata stored in the same device are stored in different dies or banks to reduce the requisite delays between accesses.

A contiguous sequence of six memory transactions 220 is shown at the bottom of FIG. 2. The first four communicate the cache lines introduced as 200 and stored in columns row/col C, row/col D, row/col B, and row/col A. Command buffer 105 can order these and metadata transactions for optimum speed performance, as detailed below. Command buffer 105 calculates metadata addresses for each cache-line address in a group of transactions and selects the device with the most metadata entries, Die 1 in this example. Command buffer 105 and memory controller 110 can then work together to minimize the number of cache-line transactions required for metadata access.

With this group of four cache lines, the first metadata access includes Die 1, because it has the most metadata entries, but also includes dies Die 0 and Die 4. The metadata for three cache lines is thus accessed in one cache-line transaction from the perspective of memory controller 115. The remaining metadata, the second metadata in die Die 1, is accessed in a second cache-line transaction.

The last two memory transactions 220, those that convey metadata, are formatted as cache-line transactions. From the perspective of buffer 105, however, these two cache-line transactions can be considered four device-specific transactions, the first three conducted in parallel to access dies Die0, Die1, and Die4 and the fourth conducted in a subsequence access to die Die1. The goal of sequencers 130 and 170 is to maximize the number of parallel device-specific accesses to minimize the number of sequential accesses, and thus the number of cache-line accesses from the perspective of memory controller 115. The number of metadata transactions for a group of four cache-line transactions is thus reduced, from the memory-controller perspective, to from four to an average number between 1 (best case) and four (worst case). The average number of controller-side metadata transactions per cache-line transaction reduces and the latency increases with the number of cache lines in a group.

Returning to FIG. 1, host 110 issues write requests WRQ with write data WDQ to memory controller 115, receiving a write acknowledgement ACK when the write is complete. Host 110 also receives read data RDQ responsive to read requests RDRQ. Memory controller 115 can use the same or different EDC on the host side and the memory side, but host 110 is not required to participate in the use of metadata for improved EDC.

Memory controller 115 includes a scheduler 125 that receives the read and write requests from host 110 and interacts with a sequencer 130 that determines from the requested addresses the requisite number of metadata accesses and orders entries in a read command/address (CA) queue 135 and a write CA and data queue 140. Sequencer 130 also manages an error-detection-and-correction (EDC) circuit 145 that calculates parity and metadata for each cache line in the write direction and uses the parity and metadata for error detection and correction in the read direction. An algorithm for the management of metadata addressing and transactions is detailed below.

Read queue 135 stores read commands and addresses in the order the commands are to be executed. Write queue 140 stores write commands, addresses, and data in the order the write commands are to be executed. A CA interface 150 communicates buffer commands and addresses BCA, so called to distinguish them from DRAM-side commands and addresses CA. A data-and-metadata buffer 155 stores data and metadata in the write direction until they are sent to DRAMs 120 and stores data and metadata received from the DRAM until they are used by EDC circuit 145.

Command buffer 105 buffers command and address signals BCA, which is to say it facilitates the transfer of command and address signals between memory controller 115 and DRAM devices 120. The operational characteristics of the controller-side signals BCA can be the same or different from the memory side. A decoder 160 decodes commands BCA into commands suitable for DRAMs 120 and stores the decoded commands in a CA queue 165 with the associated cache-line addresses.

A sequencer 170 runs an algorithm that replicates the metadata addressing and transaction ordering of sequencer 130 of memory controller 115 so memory controller 115 receives metadata in transactions of expected number and format. Decoder 160 also manages a command switch 175 that alternatively provides (1) the same address to all devices 120 to select a rank of banks for a cache-line transaction, (2) a device-specific address to access metadata in one of DRAM devices 120, or (3) different device-specific addresses to simultaneously access metadata from different column addresses in different DRAMs 120. In the example of FIG. 2, command buffer 105 can address any of cache-line addresses characterized by a row/col address in the space reserved for data and parity to access a cache line or can access different addresses in each of dies Die [4:0] to simultaneously access multiple 32b blocks or sets of metadata. A simultaneous access to columns row/col E0, F1, and E4 provides three sets of metadata from dies Die 0, Die 1, and Die 4 in one memory transaction and a subsequent access to column row/col G1 provides one set of metadata from a single die Die 1. Metadata transactions are managed by command buffer 105 and thus do not require the involvement of memory controller 115 or use of command bandwidth over channel BCA.

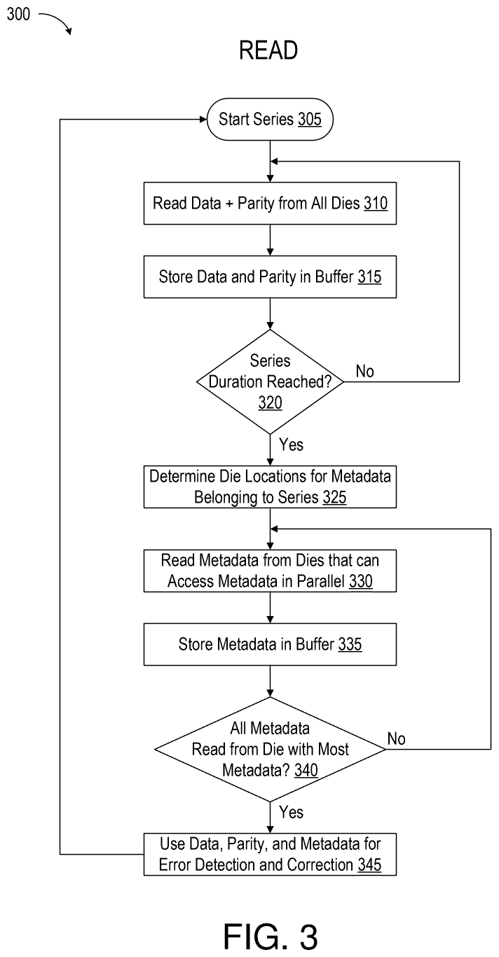

FIG. 3 is a flowchart 300 illustrating a method, coordinated by memory controller 115 and command buffer 105, to read cache lines and metadata from DRAM devices 120 and use returned data, parity, and metadata for EDC. This method is consistent with and can be informed by the example of FIG. 2.

The method begins with memory controller 115 issuing a series of read commands BCA, which decoder 160 considers in groups of four (step 305). Decoder 160 and command switch 175 issues a read command to a cache-line addresses across all DRAMs 120 to read a cache line, a set of data and parity bits (310). Memory controller 115 stores the data and parity bits, delivered via links DQ [4:0], in buffer 155 as they are received (315). Per decision 320, steps 310 and 315 are repeated until all four cache lines are stored in buffer 155. The cache-line addresses associated with the commands in queue 165 are retained in queue 165 until a metadata address is calculated for each cache-line address.

Next, in step 325, sequencer 170 determines from the cache-line addresses in queue 165 the die-specific addresses of the metadata. Step 325 is also conducted by sequencer 130 so memory controller 115 can make sense of returning metadata. (The steps in flowchart 300 are ordered for illustration; in practice, these steps can overlap, and the transactions pipelined.) Decoder 160 then directs sequencer 170 to read the metadata from the dies that can be accessed in parallel, which includes the die or dies with the highest number of metadata entries (step 330). The metadata from each transaction is conveyed to and stored in data and metadata buffer 155 (step 335) until, per decision 340, all metadata is read from the die or dies with the most metadata. Memory controller 115 uses EDC circuit 145 to use the data, parity, and metadata bits in buffer 155 to provide EDC for each cache line requested by host 110. The error-corrected data is conveyed to host 110. In some embodiments, a separate EDC circuit (not shown) in memory controller 115 uses an EDC protocol different from that of EDC circuit 145 to manage errors in the communication channel between host 110 and memory controller 115.

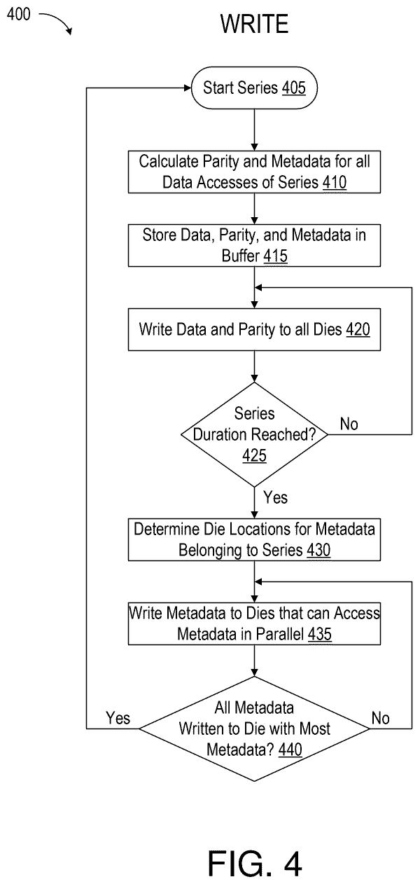

FIG. 4 is a flowchart 400 illustrating a method, coordinated by memory controller 115 and command buffer 105, to write cache lines and metadata from memory controller 115 to DRAM devices 120 in a manner consistent with the example of FIG. 2. The method begins (step 410) with EDC circuit 145 calculating parity and metadata for a series of cache lines received from host 110 via write connections WDQ and accompanied by a write request WRQ. These transactions are grouped into e.g. four cache-line accesses. Data and related parity bits are combined into cache lines and stored in buffer 155 with corresponding metadata (415).

Memory controller 115, using CA interface 150 and buffer 155, writes the first set of data and parity bits as a 640b cache line across all five DRAM dies 120 via data link groups DQ [4:0] (step 420). Each data link group services one die with eight links, and each DRAM device 120 communicates in 16b bursts in support of 128b access. Per decision 425, this write process is repeated until the grouped series of four cache lines are all stored in their respective cache-line addresses. Next, decoder 160 calculates the metadata address for each cache-line address in the series (step 430). Decoder 160 then directs sequencer 170 to write the metadata to the dies that can be accessed in parallel, which includes the die or dies with the highest number of metadata entries (step 435). The metadata for each cache line is conveyed to and stored in a DRAM device 120 until, per decision 440, all metadata is written to the die or dies with the most metadata entries. Memory controller 115 then uses EDC circuit 145 to use the data, parity, and metadata bits in buffer 155 to provide EDC for each cache line requested by host 110. The error-corrected data is then conveyed to host 110. In some embodiments, a separate EDC circuit (not shown) in memory controller 115 uses an EDC protocol different from that of EDC circuit 145 to manage errors in the communication channel between host 110 and memory controller 115. Memory controller 115 uses write acknowledgement signal ACK to signal completion of each cache-line write.

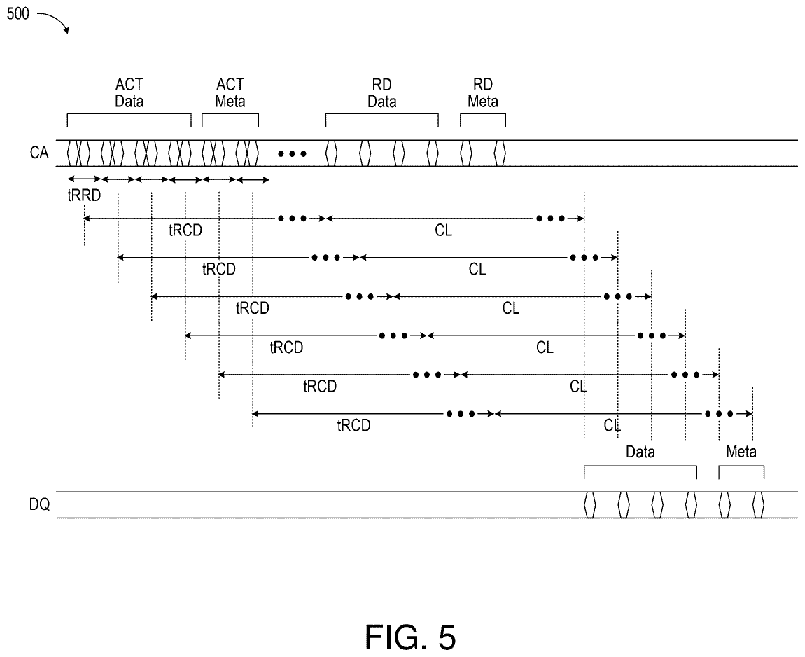

FIG. 5 is a timing diagram 500 illustrating how a sequence of four read transactions, cache lines with parity and data bits, and two related metadata transactions can be pipelined to maximize communication bandwidth. Pipelining allows the read and metadata transactions to progress through their respective stages concurrently, with all available time slots ideally in simultaneous use, to increase the number of transactions that can be processed per unit time. The delay D_{EDC} until the last block of metadata is accessed, the latency to the start of error correction, is:

$${D}_{EDC} = ( {n}_{data} + {n}_{meta} ) {t}_{RRD} + {t}_{RCD} + CL \qquad EQ ( 1 )$$

where:
   n_{data} is the number of cache line transactions;
   nₘₑₜₐ is the number of metadata transactions;
   t_{RRD} is the row-to-row delay, or the minimum time required between activating two different rows within the same bank of DRAM;
   t_{RCD} is the row cycle delay, or the total time required from when a row is activated until another row can be activated in the same bank; and
   CL is the column-access-strobe latency, or the number of clock cycles it takes to begin providing requested data after receiving a Column Address Strobe (CAS) signal.

With reference to FIG. 1, metadata accesses require sequencer 170 to access multiple DRAMs in parallel using different component addresses, and to perform anywhere from one to four metadata accesses responsive to four cache line accesses. The organization of returned metadata is thus dependent upon queued cache-line addresses. Command buffer 105 and memory controller 115 used the same algorithm to calculate metadata addresses from cache-line addresses so that memory controller 115 can anticipate the organization of returned metadata.

$${BG}_{meta} = BG \qquad EQ ( 2 )$$

$${BA}_{meta} = 〈 ¬ {BA}_{n} , {BA}_{n - 1} , ⋯ , {BA}_{0} 〉 \qquad EQ ( 3 )$$

where:
   BG is Bank Group for a cache-line address.
   BGₘₑₜₐ is Bank Group for metadata corresponding to a cache-line address.
   BA is Bank Address for a cache-line address.
   BAₘₑₜₐ is a Bank Address for metadata corresponding to a cache-line address.

Equation (3) describes how a bank address for metadata is constructed from a bank address for a cache line. The terms BA(n:0) represent individual bits of the bank address, where BAn is the most significant bit (MSB) and BAO is the least significant bit (LSB). “¬BAn” is the logical negation or inverse of the MSB of the cache-line bank address.

Memory devices can include stacks of memory dies, with each die including groups of independently addressable banks. The following set of equations can be used in modules in which DRAMs 120 of FIG. 1 are multi-die packages.

$${SID}_{meta} = 〈 ¬ {SID}_{n} , {SID}_{n - 1} , ⋯ , {SID}_{0} 〉 \qquad EQ ( 4 )$$

$${c}_{1} = \frac{{a}_{data}}{{a}_{meta}} \qquad EQ ( 5 )$$

$${c}_{2} = {n}_{die} \cdot {c}_{1} \qquad EQ ( 6 )$$

$${R}_{offset} = ( {c}_{2} - 1 ) ⌊ \frac{{R}_{max}}{2} ⌋ \qquad EQ ( 7 )$$

$${c}_{3} = ⌊ \frac{R}{{c}_{2}} ⌋ \qquad EQ ( 8 )$$

$${R}_{meta} = {c}_{3} + {R}_{offset} \qquad EQ ( 9 )$$

$${die}_{meta} = ⌊ \frac{R - {c}_{3} {c}_{2}}{{c}_{1}} ⌋ \qquad EQ ( 10 )$$

$${n}_{DQ , meta} = \frac{{n}_{DQ}}{{c}_{1}} \qquad EQ ( 11 )$$

$${DQ}_{meta} 〈 0 〉 = {n}_{DQ , meta} \cdot mod ( R - {c}_{3} {c}_{2} , {c}_{1} ) \qquad EQ ( 12 )$$

$${DQ}_{meta} 〈 i 〉 = {DQ}_{meta} 〈 i - 1 〉 + 1 \qquad EQ ( 13 )$$

where:
   SID is Stack ID for a multiple-die stack;
   a_{data} is Access width per data die, e.g., 128b;
   aₘₑₜₐ is Access width of metadata per die, e.g., 32b;
   R_{offset} is Starting row of metadata range;
   dieₘₑₜₐ is Die on which metadata for R are stored;
   n_{DQ} is Number of DQ traces or pins; and
   DQₘₑₜₐ is DQ on which metadata is stored.

The foregoing examples divide a row address space across five dies into two ranges, one that stores 640b cache lines and another 32b blocks of metadata. 640b/(512b+128b+32b)=95.2% and 32b/(512b+128b+32b)=4.8%, so about 5% of available memory is allocated for metadata. Each 32b location for metadata storage is on only one die, and metadata and data/parity bits are stored in different banks (e.g., metadata for banks 0 to 15 in banks 16 to 31 and metadata for banks 16 to 31 in banks 0 to 15) so access sequences can be spaced by delay t_{RRD} instead of the longer delay t_{RC}.

Command buffers, like buffer 105 of FIG. 1, can support a broad range of actions in support of EDC. The following Table 1 summarizes actions taken by a command buffer, in accordance with one embodiment, responsive to well-known DRAM commands. In this and other embodiments detailed herein, data and parity bits are stored in a different range of addresses than are the metadata. The two ranges are called the “range of data” and the “range of metadata” in Table 1. Other organizations of data and metadata can be used.

TABLE 1
Buffer Commands and Actions

| | | BG, | | | |
|---|---|---|---|---|---|
| Command | SID | BA | RA | CA | Action |
| ACT | valid | valid | in range | n/a | Send activate to all die in parallel. |
| | | | of data | | Calculate metadata info (SID, BA, RA, |
| | | | | | die, DQ). |
| | | | | | Put metadata info into queue. |
| RD/WR | valid | valid | n/a | valid | Send column command to all die in |
| | | | | | parallel. |
| | | | | | Identify corresponding queue entry by |
| | | | | | SID, BA, RA. |
| | | | | | Add column address and RD/WR flag to |
| | | | | | queue entry. |
| | | | | | If write, the controller must have |
| | | | | | calculated metadata and retained it until |
| | | | | | the metadata is written. |
| | | | | | If read, the controller receives data and |
| | | | | | retains the data until the corresponding |
| | | | | | metadata is received. |
| ACT | n/a | n/a | n MSB | n/a | Decode LSB bits of RA: 1b designates |
| | | | bits in | | read or write, other bits can make other |
| | | | range of | | adjustments, e.g., program t_{RCD}, set |
| | | | metadata | | number of queue entries to get, or select |
| | | | e.g., 5 | | specific queue entries. |
| | | | MSB | | Get queue entries of the requested |
| | | | bits if | | number and type (RD or WR). |
| | | | 5% used | | Issue different internal ACT commands |
| | | | for | | to dies identified in queue entries (No |
| | | | metadata | | Operation (NOP) when no queue entry |
| | | | (32 > | | has metadata on a device). |
| | | | 20) | | Wait t_{RCD} (other commands can be |
| | | | | | executed during the wait). |
| | | | | | If read |
| | | | | | Issue different internal RD |
| | | | | | commands to dies identified in |
| | | | | | queue entries (NOP when no |
| | | | | | queue entry has metadata on a |
| | | | | | device). |
| | | | | | Controller extracts metadata from |
| | | | | | correct DQ link group and |
| | | | | | combines with retained data to |
| | | | | | perform desired RAS operation. |
| | | | | | If write |
| | | | | | Issue different internal RD |
| | | | | | commands to dies identified in |
| | | | | | queue entries (NOP when no |
| | | | | | queue entry has metadata on a |
| | | | | | device). |
| | | | | | Modify data belonging to DQ |
| | | | | | where metadata has changed to |
| | | | | | do read-modify-write operation. |
| | | | | | Issue different internal WR |
| | | | | | commands to dies identified in |
| | | | | | queue entries (NOP when no |
| | | | | | queue entry has metadata on a |
| | | | | | device). |

While the invention has been described with reference to specific embodiments thereof, it will be evident that various modifications and changes may be made thereto without departing from the broader spirit and scope of the invention. For example, data buffers can be included between memory controller 115 and DRAM devices 120, in which case command buffer 105 can be modified to interact with the data buffers to remove some or all the metadata processing performed by controller 115. Moreover, some components are shown directly connected to one another while others are shown connected via intermediate components. In each instance the method of interconnection, or “coupling,” establishes some desired electrical communication between two or more circuit nodes, or terminals. Such coupling may often be accomplished using a number of circuit configurations, as will be understood by those of skill in the art. Therefore, the spirit and scope of the appended claims should not be limited to the foregoing description. Only those claims specifically reciting “means for” or “step for” should be construed in the manner required under the sixth paragraph of 35 U.S.C. § 112.

What is claimed is:

1. A command and address buffer for accessing memory devices, the buffer comprising:
a command queue to store commands; and
a sequencer coupled to the command queue, the sequencer to:
sequentially access, for each of the stored commands, a cache line stored across the memory devices at a cache-line address;
calculate, for each of the cache-line addresses, a metadata address for metadata stored in only one of the memory devices and corresponding to the cache line at the cache-line address; and
simultaneously access sets of the metadata at different device-specific addresses.

2. The buffer of claim 1, further comprising confining the cache-line addresses to a first range of memory addresses and the metadata addresses to a second range of memory addresses.

3. The buffer of claim 1, wherein the buffer divides storage across the memory devices into a first range of the cache-line addresses and a second range of the metadata addresses.

4. The buffer of claim 1, further comprising a command decoder to receive and decode buffer commands to produce the commands in the command queue.

5. The buffer of claim 1, further comprising a command switch coupled to the sequencer to apply each of the cache-line addresses to all the memory devices simultaneously and to apply the different device-specific addresses to different ones of the memory devices simultaneously.

6. The buffer of claim 1, wherein the commands in the command queue include an activate command.

7. The buffer of claim 6, wherein the activate command is associated with a first row address in a first range of the cache-line addresses, and wherein the metadata address calculated for the metadata corresponding to the row address includes a second row address in a second range outside of the first range.

8. A method for storing a block of metadata for each cache line in a series of cache lines, the method comprising:
reading a first cache line from a first cache-line address across a number of memory devices;
reading a second cache line from a second cache-line address across the number of memory devices;
calculating a first metadata address as a function of the first cache-line address;
calculating a second metadata address as the function of the second cache-line address; and
simultaneously reading first metadata from the first metadata address on a first of the memory devices and second metadata from the second metadata address on a second of the memory devices.

9. The method of claim 8, wherein the first cache line includes first data and first parity bits and the second cache line includes second data and second parity bits, the method further comprising correcting the first data using the first parity bits and the first metadata; and
correcting the second data using the second parity bits and the second metadata.

10. The method of claim 8, further comprising storing the first cache-line address and the second cache-line address with additional cache-line addresses.

11. The method of claim 10, further comprising calculating additional metadata addresses for the additional cache-line addresses, each additional metadata address directed to just one of the memory devices, and determining which of the memory devices has the highest number of the metadata addresses for the stored cache-line addresses.

12. The method of claim 11, further comprising directing a contiguous sequence of read transactions to the memory device with the highest number of the metadata addresses.

13. A memory controller comprising:
a command scheduler to schedule data commands responsive to host requests, each of the data commands directed to a cache-line address;
a command queue to store a first number of the data commands;
error-detection-and-correction (EDC) circuitry to generate a block of metadata for each of the data commands in the command queue; and
a sequencer to:
calculate a metadata address for each of the blocks of metadata using the cache-line addresses; and
determine a second number of sequential metadata accesses required to access the blocks of metadata for all the first number of the data commands.

14. The memory controller of claim 13, wherein each of the blocks of metadata consists of a third number of metadata bits and each of the cache lines includes a fourth number of cache-line bits at least five times the third number.

15. The memory controller of claim 13, wherein at least one of the metadata commands in the second number of metadata commands specifies multiple row addresses.

16. The memory controller of claim 13, wherein the second number varies with the stored data commands.

17. The memory controller of claim 16, wherein the second number varies between one and the first number.

18. The memory controller of claim 13, further comprising a command interface to issue the data commands and a data buffer to communicate a cache line of data for each of the data commands, the data buffer supporting multiple link groups to communicate each cache line of data in parallel over the link groups.

19. The memory controller of claim 18, the data buffer to communicate each of the blocks of metadata over only one of the link groups.

20. The memory controller of claim 19, the data buffer to communicate multiple of the blocks of metadata simultaneously over respective link groups.
